(19) United States
(12) Patent Application Publication
(10) Pub. No.: US 2023/0279264 A1
(43) Pub. Date: Sep. 7, 2023

(54) METHOD OF MANUFACTURING LEATHER

(71) Applicant: WHITE CO., LTD., Yangju-su (KR)

(72) Inventor: Tonghan YOON, Yangju-si (KR)

(21) Appl. No.: 18/117,692

(22) Filed: Mar. 6, 2023

(30) Foreign Application Priority Data
Mar. 4, 2022 (KR) 10-2022-0028058
Apr. 19, 2022 (KR) 10-2022-0048359

(51) Int. Cl. C09D 183/04

(52) U.S. Cl. CPC C09D 183/04

(57) ABSTRACT

Provided is a method of manufacturing leather, comprising: preparing fabric including soaking, fleshing, liming, reliming, band knifing, deliming, and bating of natural leather; shaving the prepared fabric to a uniform thickness; neutralizing the shaved fabric to a pH of 5 to 7; flame retardant processing of performing a flame retardant treatment on the neutralized fabric with a composition for manufacturing leather; and drying the flame retardant treated fabric.

### CROSS-REFERENCE TO RELATED APPLICATIONS

This application claims priority under 35 U.S.C. § 119 to Korean Patent Application No. 10-2022-0028058, filed on Mar. 4, 2022 and Korean Patent Application No. 10-2022-0048359, filed on Apr. 19, 2022, in the Korean Intellectual Property Office, the disclosure of which is incorporated herein by reference in its entirety.

### TECHNICAL FIELD

The following disclosure relates to a method of manufacturing leather.

### BACKGROUND

Leather is a tough skin that covers the body of an animal, which is widely used in most fields. As such, the leather is always used closely in our daily lives, and if the after-flame time or the after-glow time increases in case of fire, the fire may spread and cause a huge fire, causing great damage.

Methods of manufacturing leather according to the related art generally include a tanning process in which various tanning agents are used to change animal protein into mineral to improve heat resistance and prevent decay, and among them, 90% or more of leather manufacturers employ trivalent chromium, a heavy metal with excellent tanning effect.

However, trivalent chromium employed in the method of manufacturing leather is highly likely to be oxidized to hexavalent chromium due to constant temperature, pH, basicity, and the like, and has many difficulties in treating solid waste. Further, even if the animal protein is converted to mineral in the tanning process, the unique smell of leather is unpleasant to consumers, and thus the preference for leather is slightly lowered. In addition, in order to adsorb chromium to leather as in the related art, about 30 to 50% more chromium than the actual bonding amount is used, and of these, only about 50 to 70% is bound to leather, and the remaining 30 to 50% is not able to be bound to leather naturally but leaks into wastewater, causing many environmental problems.

In addition, there is a disadvantage in that textural stability of leather is deteriorated by performing a pickling process, which is a process of penetrating acid into the leather and adjusting the pH to a suitable pH for a subsequent chrome tanning process.

Therefore, there is a need to develop a method of manufacturing leather capable of maximizing a flame retardant effect while being environmentally friendly without using chromium.

### SUMMARY

An embodiment of the present disclosure is directed to providing a method of manufacturing leather capable of maximizing a flame retardant effect while being environmentally friendly.

The above and other objects of the present disclosure may all be achieved by the present disclosure described below.

In one general aspect, there is provided a method of manufacturing leather.

According to an embodiment, the method of manufacturing leather may comprise: preparing fabric including soaking, fleshing, liming, reliming, band knifing, deliming, and bating of natural leather; shaving the prepared fabric to a uniform thickness; neutralizing the shaved fabric to a pH of 5 to 7; flame retardant processing of performing a flame retardant treatment on the neutralized fabric with a composition for manufacturing leather; and drying the flame retardant treated fabric.

The method may further comprise: tanning the prepared fabric in a chrome-free tanning method.

According to another embodiment, the method of manufacturing leather may further comprise: direct-tanning the prepared fabric with nitrogen-based syntans.

The method may further comprise, after the flame retardant processing, retanning the flame retardant treated fabric.

The method may further comprise, after the retanning, dyeing the retanned fabric using a dye.

The method may further comprise, after the dyeing, fatliquoring the dyed fabric with a fatliquoring agent.

The drying may include, after the fatliquoring, drying the fatliquored fabric.

The drying step may include vacuum drying, wet toggle, natural drying (hanging), humidity control (conditioning), vibration, milling, and toggle.

The method may further comprise finishing a surface of the dried fabric with a binder.

The composition for manufacturing leather may comprise hydroxide and borax (Na₂B₄O₇·10H₂O).

The composition for manufacturing leather may comprise 0.1 to 5 parts by weight of hydroxide; and 0.1 to 5 parts by weight of borax, based on 100 parts by weight of shaving leather.

The hydroxide may contain at least one of 0.05 to 2.5 parts by weight of aluminum hydroxide (Al(OH)₃); and 0.05 to 2.5 parts by weight of magnesium hydroxide (Mg(OH)₂).

The composition for manufacturing leather may further comprise: based on 100 parts by weight of the shaving leather, at least one of 1 to 10 parts by weight of a first liquid agent; and 1 to 10 parts by weight of a second liquid agent.

The first liquid agent may contain ceramic, and the second liquid agent may contain titanium dioxide.

The first liquid agent may contain 92 to 99% by weight of ethanol; 0.1 to 5% by weight of butanone; and 0.1 to 3% by weight of ceramic.

The second liquid agent may contain 90 to 99% by weight of water; 0.1 to 5% by weight of quartz; 0.1 to 3% by weight of ethanol; and 0.1 to 3% by weight of titanium dioxide (TiO₂).

The composition for manufacturing leather may further comprise: based on 100 parts by weight of the shaving leather, 1 to 10 parts by weight of silica.

The composition for manufacturing leather may further comprise: based on 100 parts by weight of the shaving leather, 1 to 10 parts by weight of a third liquid agent.

The third liquid agent may contain 50 to 80% by weight of water; 10 to 40% by weight of polydimethyl siloxane hydroxyl terminated; and 1 to 15% by weight of dimethyl siloxane.

A weight ratio of the hydroxide and borax may be 0.5:1 to 1.5:1.

A weight ratio of the total weight of the first liquid agent and the second liquid agent to the borax may be 15:1 to 5:1.

A weight ratio of the total weight of the borax, the first liquid agent, and the second liquid agent to the total weight of the silica and the third liquid agent may be 0.5:1 to 1.5:1.

### BRIEF DESCRIPTION OF THE DRAWINGS

FIG. 1 shows a process chart of a method of manufacturing leather of the present disclosure.

FIG. 2 shows a Dose laboratory drum used in the method of manufacturing leather of the present disclosure.

FIG. 3 shows a SUS laboratory drum used in the method of manufacturing leather of the present disclosure.

FIG. 4 shows a Wood laboratory drum used in the method of manufacturing leather of the present disclosure.

FIG. 5 shows a Main drum used in the method of manufacturing leather of the present disclosure.

FIG. 6 shows experimental results on the after-flame time, the after-flame time and the smoke density of Examples 1 to 5 of the present disclosure.

FIG. 7 shows experimental results on the after-flame time, the after-flame time and the smoke density of Examples 6 to 8 of the present disclosure.

FIG. 8 shows experimental results on heat resistance of Examples 1 to 8 of the present disclosure.

FIG. 9 shows experimental results on after-flame time, after-glow time, smoke density, and heat resistance of Comparative Example 1.

FIG. 10 is an image of a Meker burner in which the after-flame time, the after-glow time, and the smoke density of the present disclosure were measured.

FIG. 11 is an image of an oven in which the heat resistance of the present disclosure was measured.

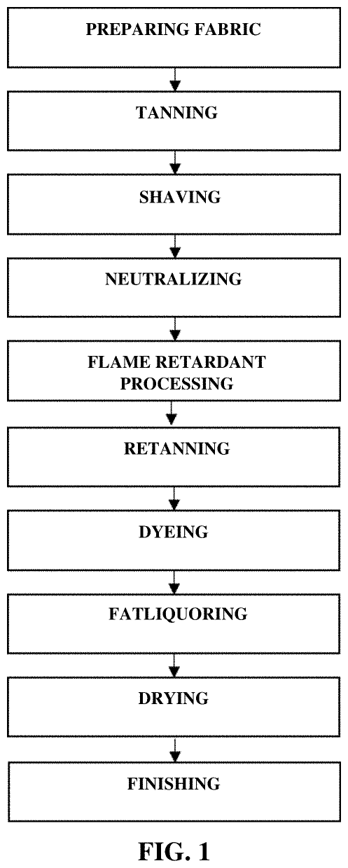

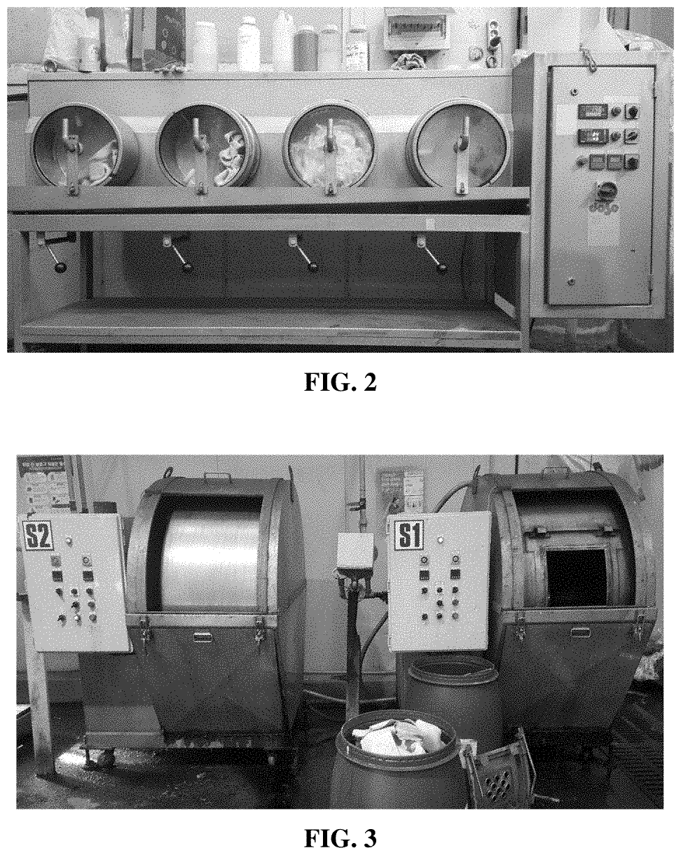

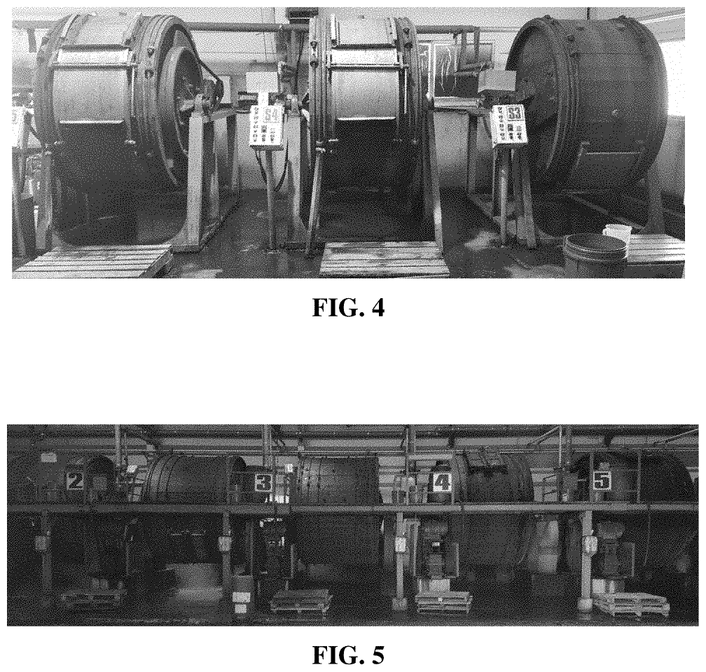

### DETAILED DESCRIPTION OF EMBODIMENTS

Hereinafter, the present disclosure will be described in more detail.

In the description of the present disclosure, if it is determined that a detailed description of related known technologies may unnecessarily obscure the subject matter of the present disclosure, a detailed description thereof will be omitted.

When ‘comprise’, ‘have’, ‘composed of’, and the like, described herein are used, other parts may be added unless ‘merely’ is described. In the case where a component is expressed in the singular, the same shall be construed as meaning the plural unless otherwise specifically stated.

In addition, in the interpretation of the components, even if there is no separate explicit description, it is interpreted as including the error range.

Further, as used herein, ‘X to Y’ indicating a range means ‘X or more and Y or less’.

In addition, as used herein, the term after-flame time (sec) means the time until the burning state with the flame of leather is stopped after the ignition source has been removed.

Further, as used herein, the term after-glow time (sec) means the time until the burning state stops without burning the flame after the ignition source has been removed. In this case, the time during which after-flame occurs is excluded.

In addition, as used herein, the smoke density (DM) means an amount of smoke generated from ignition of the flame of the burner to the end of the after-glow.

In addition, in the present specification, the fabric may include raw hides, wherein the raw hides refer to leather obtainable through primary processing from slaughtered livestock. Therefore, the terms fabric, rawhide and leather may be employed interchangeably.

In addition, as used herein, the drum serves to evenly mix the raw hide and the chemicals used in each step, and is not limited by the size, type, and the like of the drum.

Further, rotation as used herein refers to rotating a drum containing raw hides and chemicals, i.e., a process of making raw hides and chemicals mix well with each other.

Method of Manufacturing Leather

One aspect of the present disclosure relates to a method of manufacturing leather.

According to an embodiment, the method of manufacturing leather may comprise: preparing fabric including soaking, fleshing, liming, reliming, band knifing, deliming, and bating of natural leather; shaving the prepared fabric to a uniform thickness; neutralizing the shaved fabric to a pH of 5 to 7; flame retardant processing of performing a flame retardant treatment on the neutralized fabric with a composition for manufacturing leather; and drying the flame retardant treated fabric.

Hereinafter, each step will be described in detail.

The preparing of the fabric includes soaking, fleshing, liming, reliming, band knifing, deliming, and bating of natural leather.

The soaking process is to immerse the salted leather in water to reabsorb moisture, thereby restoring leather to a soft and flexible state, and removing dirt, salt, water-soluble protein, and the like, that are attached to the leather.

The fleshing process is to remove the fat attached to the back side of the raw hides in which the fat may be removed using a mechanical blade and roller.

The liming process is to remove hairs and unnecessary soluble proteins from leather using alkaline chemicals.

The alkaline chemical may be NaHS, Na₂S and Ca(OH)₂, and the like, and the fat contained in natural leather may be removed through saponification with the alkaline chemicals. The saponification time may be 6 hours to 30 hours, specifically 12 hours to 25 hours, and in the above time range, it is possible to appropriately remove the oil remaining in the raw material skin, resulting in achieving an economic effect.

The reliming process is to remove hair roots and dirt from the leather in order to impart flexibility to the leather that has finished the liming process.

The band knifing process is a process of primarily adjusting a thickness of pelt by additionally performing a splitting (band knifing, pelt division) process which divides the pelt into two layers, grain and split, depending on the purpose and use of the final leather.

The deliming process is to remove lime used in the lime process to thereby lower the pH. Since the pH of the lime-treated leather is high in the depilation process, the subsequent bating process is not able to be performed, and thus the deliming process is required.

The bating process is to remove unnecessary proteins of leather with a proteolytic enzyme, which is able to impart flexibility and elongation to leather and clean the grain surface.

In the method of manufacturing leather of the present disclosure, a pickling process may be excluded. By excluding the pickling process, there is an advantage in that the structure of the leather is further stabilized, thereby maximizing the flame retardant effect.

The shaving step includes a process of cutting the prepared fabric to a uniform thickness.

The shaving step is to make the thickness of the fabric constant, and the back side of the fabric may be cut so that the thickness of the fabric is 1.0 mm to 1.2 mm, but the thickness of the fabric is not limited thereto.

After the shaving step, a water washing process of washing the fabric with water may be further included, but the present disclosure is not limited thereto.

The neutralizing step includes neutralizing the shaved fabric to a pH of 5 to 7.

The neutralization step is to increase the pH of the inside and outside of the raw material skin to facilitate penetration and bonding of a dye or fatliquoring agent into the raw material skin since the fabric is acidified to a pH of approximately 3 to 4 after the tanning process, it is difficult to penetrate the dye and/or fatliquoring agent employed in the dyeing and/or fatliquoring step to be performed subsequently.

A neutralizing agent used in the neutralization step may be at least one of aluminum hydroxide (Al(OH)₃), magnesium hydroxide (Mg(OH)₂), sodium hydrogen carbonate (NaHCO₃), and sodium formate (HCOONa), but is not limited thereto.

The flame retardant processing step includes a process of flame retardant treatment on the neutralized fabric with a composition for manufacturing leather.

The method may further comprise: tanning the prepared fabric in a chrome-free tanning method.

The tanning step may form a chemical bond in the collagen proteins of the leather to provide a stable structure, while simultaneously providing heat resistance, decay resistance, flexibility, and elasticity.

The chrome-free tanning method may be any method commonly used in the art.

Specifically, in the chrome-free tanning method in the present disclosure, borax may be employed, but the present disclosure is not limited thereto.

For example, based on 100 parts by weight of leather, the borax may be included in an amount of 0.1 to 5 parts by weight, specifically 0.5 to 3 parts by weight, for example, 0.1, 0.2, 0.3, 0.4, 0.5, 0.6, 0.7, 0.8, 0.9, 1, 2, 3, 4 or 5 parts by weight. Within this range, it is possible to soften leather and prevent hardening after drying, and the like.

When chrome-free tanning is applied to the method of manufacturing leather of the present disclosure, heat resistance may be lowered, but there is an advantage in preventing a decrease in heat resistance by applying the composition for manufacturing leather in the flame retardant processing step to be performed later.

The tanning step may be comprised before the shaving step, but the present disclosure is not limited thereto.

The composition for manufacturing leather used in the flame retardant processing step may comprise hydroxide and borax (Na₂B₄O₇·10H₂O).

The composition for manufacturing leather may comprise 0.1 to 5 parts by weight of hydroxide; and 0.1 to 5 parts by weight of borax, based on 100 parts by weight of shaving leather.

The shaving may refer to a process of shaving a fabric to be leather to a uniform thickness.

The hydroxide may contain at least one of aluminum hydroxide (Al(OH)₃) and magnesium hydroxide (Mg(OH)₂), wherein the hydroxide may exhibit a flame retardant effect or a flame resistant effect on leather, and may improve fire resistance, weather resistance, and durability of leather.

The hydroxide may be included, based on 100 parts by weight of shaving leather, in an amount of 0.1 to 5 parts by weight, specifically 0.5 to 3 parts by weight, for example, 0.1, 0.2, 0.3, 0.4, 0.5, 0.6, 0.7, 0.8, 0.9, 1, 2, 3, 4 or 5 parts by weight. Within this range, it is possible to impart a flame retardant effect or a flame resistant effect to leather without deterioration of the quality of leather.

The hydroxide may contain at least one of aluminum hydroxide (Al(OH)₃) and magnesium hydroxide (Mg(OH)₂).

The aluminum hydroxide is an amphoteric hydroxide of aluminum, and is known to be gelated when in contact with water for a long time, and used as an adsorbent/ion exchanger, a fixative for chromatography, an antacid, and the like.

The composition for manufacturing leather may contain aluminum hydroxide (Al(OH)₃) in an amount of 0.05 to 2.5 parts by weight, specifically 0.1 to 1.5 parts by weight, for example, 0.05, 0.1, 0.2, 0.3, 0.4, 0.5, 0.6, 0.7, 0.8, 0.9, 1, 1.5, 2 or 2.5. Within this range, fire resistance may be improved without deterioration of the quality of leather.

The magnesium hydroxide is a hydroxide of magnesium, and is known to be well soluble in dilute acid, ammonium salt aqueous solution, and the like, and the aqueous solution thereof is alkaline, which is used as pharmaceutical products such as a laxative, an antacid, and the like.

The composition for manufacturing leather may comprise magnesium hydroxide (Mg(OH)₂) in an amount of 0.05 to 2.5 parts by weight, specifically 0.1 to 1.5 parts by weight, for example, 0.05, 0.1, 0.2, 0.3, 0.4, 0.5, 0.6, 0.7, 0.8, 0.9, 1, 1.5, 2 or 2.5. Within this range, fire resistance may be improved without deterioration of the quality of leather.

The borax is known as a material capable of being used in various ways such as wood preservative, glass, dye, pigment, artificial gems, photo dye, leather industry, pottery glaze, fire retardant, enamel, paint, textile industry, and the like.

The borax may be included, based on 100 parts by weight of shaving leather, in an amount of 0.1 to 5 parts by weight, specifically 0.5 to 3 parts by weight, for example, 0.1, 0.2, 0.3, 0.4, 0.5, 0.6, 0.7, 0.8, 0.9, 1, 2, 3, 4 or 5 parts by weight. Within this range, it is possible to impart a flame retardant effect or a flame resistant effect to leather, thereby shortening the after-glow time without deterioration of the quality of leather.

The composition for manufacturing leather may further comprise at least one of a first liquid agent and a second liquid agent.

The first liquid agent may contain ceramic, and the second liquid agent may contain titanium dioxide.

The first liquid agent may be included, based on 100 parts by weight of the shaving leather, in an amount of 1 to 10 parts by weight, specifically 3 to 7 parts by weight, for example, 1, 2, 3, 4, 5, 6, 7, 8, 9 or 10 parts by weight. Within this range, it is possible to impart a flame retardant effect or a flame resistant effect to the leather, thereby shortening the after-flame time, and reducing smoke generated until the end of the after-glow.

The second liquid agent may be included, based on 100 parts by weight of the shaving leather, in an amount of 1 to 10 parts by weight, specifically 3 to 7 parts by weight, for example, 1, 2, 3, 4, 5, 6, 7, 8, 9 or 10 parts by weight. Within this range, it is possible to impart a flame retardant or flame retardant effect to leather, thereby reducing smoke generated until the end of the after-glow.

The first liquid agent may contain ethanol, butanone, and ceramic.

The first liquid agent may contain ethanol in an amount of 92 to 99% by weight, specifically 95 to 98% by weight; butanone in an amount of 0.1 to 5% by weight, specifically 1 to 3% by weight; and ceramic in an amount of 0.1 to 3% by weight, specifically 0.5 to 2% by weight. Within this range, it is effective in shortening the burning time of leather, and it is possible to reduce smoke generated until the end of the after-glow.

The second liquid agent may contain water, quartz, ethanol, and titanium dioxide.

The second liquid agent may contain water in an amount of 90 to 99% by weight, specifically 93 to 97% by weight; quartz in an amount of 0.1 to 5% by weight, specifically 1.5 to 3.5% by weight; ethanol in an amount of 0.1 to 3% by weight, specifically 0.5 to 2% by weight; and titanium dioxide (TiO₂) in an amount of 0.1 to 3% by weight, specifically 0.5 to 1.5% by weight. Within this range, it is effective in reducing smoke generated until the end of the after-glow.

The composition for manufacturing leather may further comprise silica.

The silica may be included, based on 100 parts by weight of the shaving leather, in an amount of 1 to 10 parts by weight, specifically 3 to 7 parts by weight, for example, 1, 2, 3, 4, 5, 6, 7, 8, 9 or 10 parts by weight. Within this range, it is possible to exhibit an excellent flame retardant or flame resistant effect by increasing the leather adhesion of the composition for manufacturing leather. In addition, it is possible to improve heat resistance and durability in case of fire by increasing the heat resistance performance of leather, and thus the flame retardant effect may be exhibited more effectively.

The silica may be an aqueous type silicone resin, but is not limited thereto.

The composition for manufacturing leather may further comprise a third liquid agent.

The third liquid agent may contain, based on 100 parts by weight of the shaving leather, in an amount of 1 to 10 parts by weight, specifically 3 to 7 parts by weight, for example, 1, 2, 3, 4, 5, 6, 7, 8, 9 or 10 parts by weight. Within this range, it is possible to exhibit an excellent flame retardant or flame resistant effect by increasing the leather adhesion of the composition for manufacturing leather. In addition, it is possible to improve heat resistance and durability in case of fire by increasing the heat resistance performance of leather, and thus the flame retardant effect may be exhibited more effectively.

The third liquid agent may contain water; polydimethyl siloxane hydroxyl terminated; and dimethyl siloxane.

The third liquid agent may contain water in an amount of 50 to 80% by weight, specifically, 60 to 70% by weight; polydimethyl siloxane hydroxyl terminated in an amount of 10 to 40% by weight, specifically, 20 to 30% by weight; and dimethylsiloxane in an amount of 1 to 15% by weight, specifically, 5 to 10% by weight. Within this range, it is possible to help components constituting the composition for manufacturing leather to be easily attached to the leather. Further, it is effective even in increasing heat resistance performance of leather.

A weight ratio of the hydroxide and borax may be 0.5:1 to 1.5:1, specifically, 0.7:1 to 1.2:1, for example, 0.5:1, 0.6:1, 0.7:1, 0.8:1, 0.9:1, 1.0:1, 1.1:1, 1.2:1, 1.3:1, 1.4:1 or 1.5:1. Within this range, it is effective in shortening the after-glow time without deterioration of the quality of leather.

A weight ratio of the total weight of the first liquid agent and the second liquid agent to the borax may be 15:1 to 5:1, specifically, 12:1 to 7:1, for example, 15:1, 14:1, 13:1, 12:1, 11:1, 10:1, 9:1, 8:1, 7:1, 6:1 or 5:1. Within this range, the after-flame time and the after-glow time may be shortened, and the effect of reducing the amount of smoke generation is excellent.

A weight ratio of the total weight of the borax, the first liquid agent, and the second liquid agent to the total weight of the silica and the third liquid agent may be 0.5:1 to 1.5:1, specifically, 0.7:1 to 1.2:1, for example, 0.5:1, 0.6:1, 0.7:1, 0.8:1, 0.9:1, 1.0:1, 1.1:1, 1.2:1, 1.3:1, 1.4:1 or 1.5:1. Within this range, the heat resistance performance and flame retardant effect of the leather may be maximized.

The method of manufacturing leather may further comprise, after the flame retardant processing, retanning the flame retardant treated fabric.

The retanning step may increase flexibility of the leather by adjusting the acid, base, moisture, and the like, inside the leather again to facilitate dyeing of the fabric obtained after the tanning step.

The method of manufacturing leather may comprise, after the retanning, dyeing the retanned fabric using a dye.

In the dyeing step, a specific color may be imparted to the fabric using dyeing chemicals.

The method of manufacturing leather may comprise, after the dyeing, fatliquoring the dyed fabric with a fatliquoring agent.

The fatliquoring step may improve physical properties of leather such as flexibility, elasticity, tension, and the like, by administering the fatliquoring agent to leather from which oil components have been removed through soaking, depilation, and deliming processes.

The fatliquoring agent may be at least one of lecithin-based fatliquoring, flame retardant fatliquoring, and organic polymeric fatliquoring agents, but is not limited thereto.

Specifically, the lecithin-based fatliquoring agent may be NLM, and the flame retardant fatliquoring agent may be Truposol® FRF and 1045CU, but is not limited thereto.

For example, based on 100 parts by weight of sheaving leather, the NLM may be included in an amount of 1 to 10 parts by weight, specifically 3 to 7 parts by weight, the Truposol® FRF may be included in an amount of 1 to 10 parts by weight, specifically 3 to 7 parts by weight, and the 1045CU may be included in an amount of 1 to 10 parts by weight, specifically 3 to 7 parts by weight. Within this range, the physical properties of leather may be improved.

The drying may include, after the fatliquoring, drying the fatliquored fabric.

The drying step may include vacuum drying, wet toggle, natural drying (hanging), humidity control (conditioning), vibration, milling, and toggle, but is not limited thereto, and any drying method commonly used in the art may be applied.

The method of manufacturing leather may further comprise finishing a surface of the dried fabric with a binder.

The finishing step may improve durability of the leather by finishing the surface of the leather fabric with a binder to isolate the surface of the leather from the outside air.

The binder may be a mixture of an acrylic binder and a urethane binder, but is not limited thereto.

According to another embodiment, the method of manufacturing leather may further comprise direct-tanning the prepared fabric with nitrogen-based syntans.

The tanning step may form a chemical bond in the collagen proteins of the leather to provide a stable structure, while simultaneously providing heat resistance, decay resistance, flexibility, and elasticity.

The direct-tanning method may be characterized by tanning the fabric, which is obtained after the preparing of fabric excluding the pickling process, using nitrogen-based syntans and white vegetables.

Specifically, the nitrogen-based syntan may be Easy Tan F90, and the white vegetable may be White TARA, but is not limited thereto.

For example, based on 100 parts by weight of shaving leather, the Easy Tan F90 may be included in an amount of 5 to 15 parts by weight, specifically 8 to 12 parts by weight, and the White TARA may be included in an amount of 1 to 10 parts by weight, specifically 3 to 7 parts by weight. Within this range, it is possible to manufacture glossy leather with a feeling of fullness and filling.

The tanning step may be comprised before the shaving step, but the present disclosure is not limited thereto.

Since the remaining steps except for the tanning step are the same as those described above, a detailed description thereof will be omitted.

Hereinafter, the constitution and operation of the present disclosure will be described in more detail through preferred embodiments of the present disclosure. However, these exemplary embodiments are presented as preferred examples of the present disclosure and it should not be construed as limiting the present disclosure thereby in any sense.

Since contents not described herein can be technically inferred to a sufficient extent by those skilled in the art, a description thereof will be omitted.

### EXAMPLE

### Examples 1 to 5

A salted skin fabric was prepared by salting the cowhide in a conventional manner. The fabric was subjected to soaking, fleshing, liming, reliming, band knifing, deliming, bating, shaving, water washing, and neutralizing steps, followed by flame retardant treatment with a composition for manufacturing leather prepared in the amount shown in Table 1 below, and drying to manufacture leather.

With respect to the flame retardant treatment conditions, based on 100 parts by weight of fabric, 100 parts by weight of water at 40° C. and the composition for manufacturing leather were administered, and rotated in a Dose drum at a speed of 8 rpm for 60 minutes.

The drying step included vacuum drying, wet toggle, natural drying (hanging), humidity control (conditioning), vibration, milling, and toggle, wherein the drying was performed in a conventional manner.

### Examples 6 to 8

A salted skin fabric was prepared by salting the cowhide in a conventional manner. The fabric was subjected to soaking, fleshing, liming, reliming, band knifing, deliming, bating, shaving, water washing, and neutralizing steps, followed by flame retardant treatment with a composition for manufacturing leather prepared in the amount shown in Table 1 below, and drying to manufacture leather.

With respect to the flame retardant treatment conditions, based on 100 parts by weight of fabric, 100 parts by weight of water at 40° C. and the composition for manufacturing leather were administered, and rotated in a Dose drum at a speed of 8 rpm for 60 minutes.

With respect to the washing conditions, the impregnated fabric was applied to a washing fastness tester with 100 cc of 5% soap solution at 70° C.±1° C. (test method −4) or 50° C.±2° C. (test method A-2) and 10 stainless steel balls (standard) and washed for 30 minutes, and then the soap solution was discarded and replaced with 100 cc of clean hot water at 45° C.±1° C. Then, the washing fastness tester was repeatedly operated 5 times for 1 minute.

The drying step included vacuum drying, wet toggle, natural drying (hanging), humidity control (conditioning), vibration, milling, and toggle, wherein the drying was performed in a conventional manner.

### Comparative Example 1

A salted skin fabric was prepared by salting the cowhide in a conventional manner. The fabric was subjected to soaking, fleshing, liming, reliming, band knifing, deliming, bating, shaving, water washing, and neutralizing steps, followed by flame retardant treatment with a composition for manufacturing leather prepared in the amount shown in Table 1 below, and drying to manufacture leather.

With respect to the flame retardant treatment conditions, based on 100 parts by weight of fabric, 100 parts by weight of water at 40° C. and the composition for manufacturing leather were administered, and rotated in a Dose drum at a speed of 8 rpm for 60 minutes.

The drying step included vacuum drying, wet toggle, natural drying (hanging), humidity control (conditioning), vibration, milling, and toggle, wherein the drying was performed in a conventional manner.

TABLE 1

| | | | | | | | | | | Comp- |
|---|---|---|---|---|---|---|---|---|---|---|
| | | | | | | | | | | arative |
| | | | | | | | | | | Ex- |
| | | Example | | | | | | | | ample |
| (Parts by weight) | | 1 | 2 | 3 | 4 | 5 | 6 | 7 | 8 | 1 |
| Hydroxide | Al(OH)₃ | 0.5 | 0.5 | 0.5 | 0.5 | 0.5 | 0.5 | 0.5 | 0.5 | 0.5 |
| | Mg(OH)₂ | 0.5 | 0.5 | 0.5 | 0.5 | 0.5 | 0.5 | 0.5 | 0.5 | 0.5 |
| Borax | | 1 | 1 | 1 | 1 | 1 | 1 | 1 | 1 | 0 |
| First | Ethanol | 0 | 4.85 | 4.85 | 4.85 | 4.85 | 4.85 | 4.85 | 4.85 | 0 |
| liquid | Butanone | 0 | 0.1 | 0.1 | 0.1 | 0.1 | 0.1 | 0.1 | 0.1 | 0 |
| agent | Ceramic | 0 | 0.05 | 0.05 | 0.05 | 0.05 | 0.05 | 0.05 | 0.05 | 0 |
| Second | Water | 0 | 0 | 4.75 | 4.75 | 4.75 | 4.75 | 4.75 | 4.75 | 0 |
| liquid | Quartz | 0 | 0 | 0.15 | 0.15 | 0.15 | 0.15 | 0.15 | 0.15 | 0 |
| agent | Ethanol | 0 | 0 | 0.05 | 0.05 | 0.05 | 0.05 | 0.05 | 0.05 | 0 |
| | Titanium | 0 | 0 | 0.05 | 0.05 | 0.05 | 0.05 | 0.05 | 0.05 | 0 |
| | dioxide | | | | | | | | | |
| Silica | | 0 | 0 | 0 | 5 | 5 | 0 | 5 | 5 | 0 |
| Third | Water | 0 | 0 | 0 | 0 | 3.3 | 0 | 0 | 3.3 | 0 |
| liquid | Polydimethyl | 0 | 0 | 0 | 0 | 1.3 | 0 | 0 | 1.3 | 0 |
| agent | siloxane | | | | | | | | | |
| | hydroxyl | | | | | | | | | |
| | terminated | | | | | | | | | |
| | Dimethyl | 0 | 0 | 0 | 0 | 0.4 | 0 | 0 | 0.4 | 0 |
| | siloxane | | | | | | | | | |

Evaluation Method

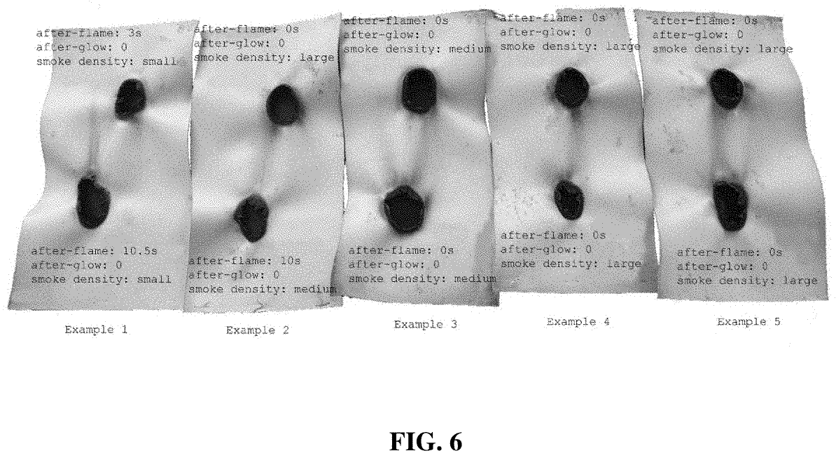

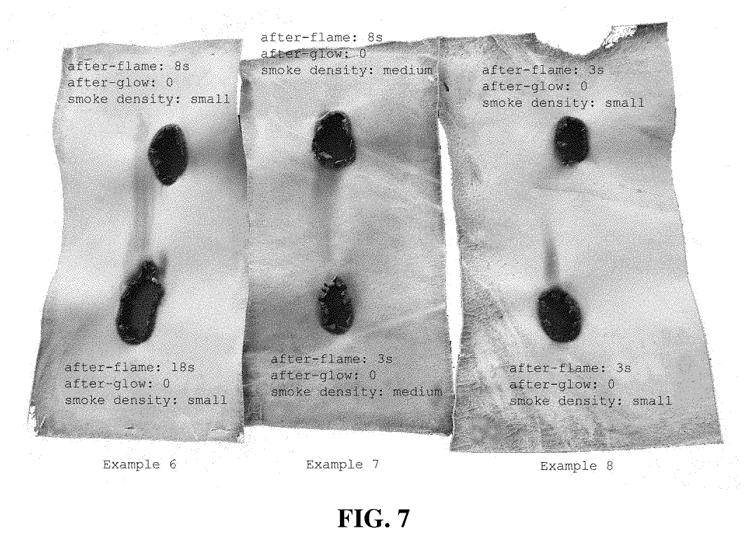

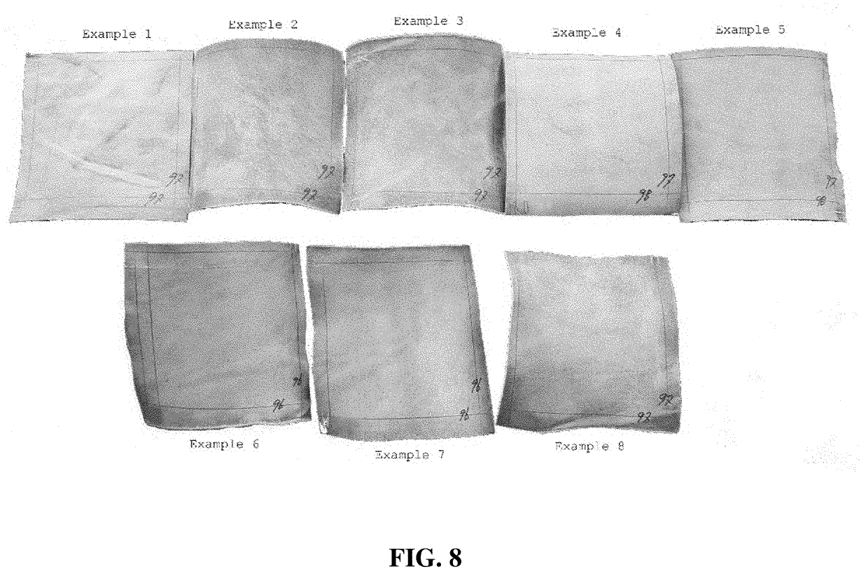

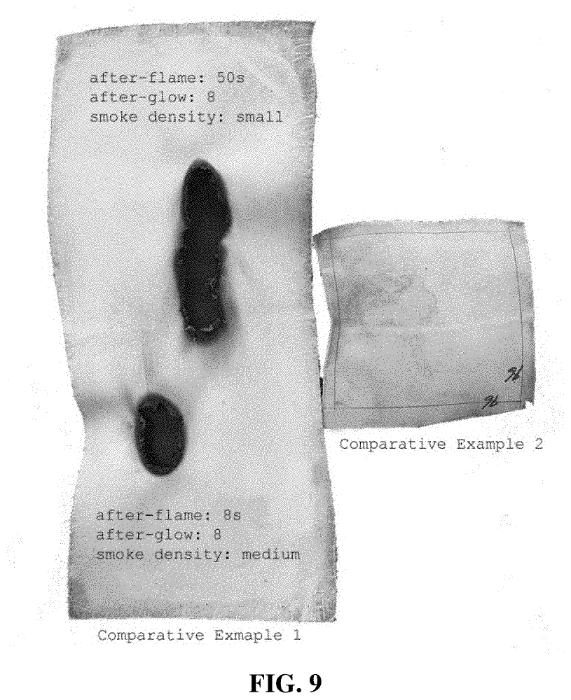

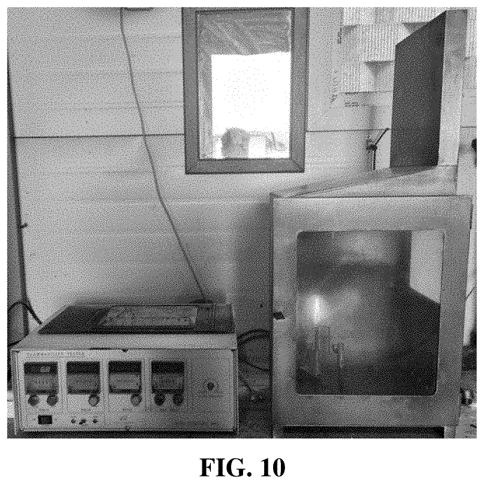

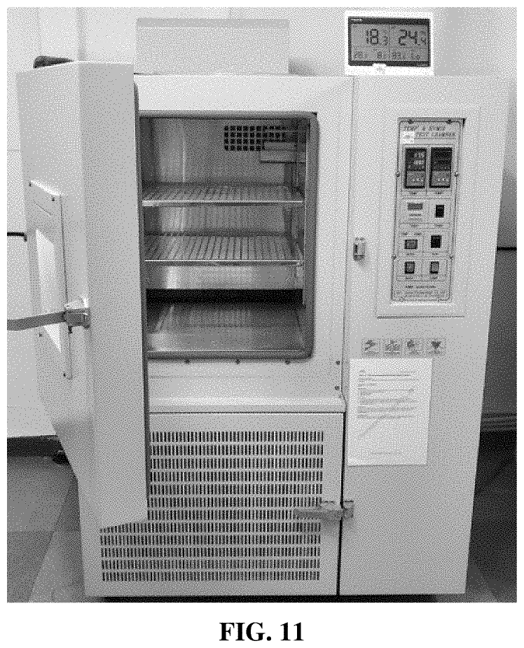

(1) After-flame time (sec): After 5 seconds from ignition of the Meker burner, the ignition was removed, and the leather (100 mm×100 mm) manufactured in Examples and Comparative Example was burned with flame. At the time when the leather was ignited, the flame was removed, and at the same time, the after-flame time (sec) was measured twice, respectively, by using the timer. Results thereof are shown in Table 2 below and FIGS. 6 to 9.

The evaluation method was conducted according to KFI (Korea Fire Institute) Test: JIS 6 1091, KSK-2619.

(2) After-glow time (sec): After 5 seconds from ignition of the Meker burner, the ignition was removed, and the leather (100 mm×100 mm) manufactured in Examples and Comparative Example was burned with flame. After cessation by removing the flame from the leather, the after-glow time (sec) was measured twice, respectively, by using the timer, and results thereof are shown in Table 2 below and FIGS. 6 to 9.

The evaluation method was conducted according to KFI (Korea Fire Institute) Test: JIS 6 1091, KSK-2619.

(3) Smoke density (DM): The amount of smoke generated until the end of the after-glow after burning with flame on the leather (100 mm×100 mm) manufactured in Examples and Comparative Example, was measured twice, respectively, and results thereof are shown in Table 2 below and FIGS. 6 to 9.

In the measurement of the amount of smoke generated, the amount of smoke generated in the chamber of FIG. 5 until the end of the after-glow was visually evaluated, wherein a case where the amount was 0% or more and less than 10% was marked as ‘small’, a case where the amount was 10% or more and less than 25% was marked as ‘medium’, and a case where the amount was 25% or more was marked as ‘large’.

The evaluation method was conducted according to KFI (Korea Fire Institute) Test: JIS 6 1091, KSK-2619.

(4) Evaluation of heat resistance: The leather (100 mm×100 mm) manufactured in Examples and Comparative Example was heated at 100° C. for 90 minutes to measure the size of the shrinked leather, and results thereof are shown in Table 3 below and FIGS. 6 to 9.

TABLE 2

| | After-flame time | | After-glow time | | | |
|---|---|---|---|---|---|---|
| | (sec): | | (sec): | | Smoke density | |
| Example 1 | 10.5 | 3 | 0 | 0 | medium | medium |
| Example 2 | 10 | 0 | 0 | 0 | Small | medium |
| Example 3 | 0 | 0 | 0 | 0 | Small | small |
| Example 4 | 0 | 0 | 0 | 0 | small | small |
| Example 5 | 0 | 0 | 0 | 0 | small | small |
| Example 6 | 18 | 8 | 0 | 0 | medium | medium |
| Example 7 | 3 | 8 | 0 | 0 | small | medium |
| Example 8 | 3 | 3 | 0 | 0 | small | small |
| Comparative | 8 | 50 | 8 | 8 | large | Medium |
| Example 1 | | | | | | |

As shown in Table 2, it could be appreciated that the method of manufacturing leather of the present disclosure was effective in shortening the after-flame and after-glow time required until the burning state was stopped, and the smoke generated in case of fire was reduced.

In addition, it could be confirmed in Example 8 in which the composition for manufacturing leather containing silica and the third liquid agent was applied to the method for manufacturing leather of the present disclosure that flame retardancy was maintained even after washing.

TABLE 3

Heat resistance (mm)

| | | |
|---|---|---|
| Example 1 | 97 | 97 |
| Example 2 | 97 | 97 |
| Example 3 | 97 | 97 |
| Example 4 | 98 | 97 |
| Example 5 | 98 | 97 |
| Example 6 | 96 | 96 |
| Example 7 | 96 | 96 |
| Example 8 | 97 | 97 |
| Comparative Example 1 | 96 | 96 |

As shown in Table 3, it could be confirmed that the leather manufactured by the method of manufacturing leather of the present disclosure had high heat resistance since the shrinkage degree of leather manufactured by the method of manufacturing leather of the present disclosure was reduced.

As described above, the present disclosure provides a method of manufacturing leather capable of maximizing a flame retardant effect while being environmentally friendly.

What is claimed is:

1. A method of manufacturing leather, comprising:
preparing fabric including soaking, fleshing, liming, reliming, band knifing, deliming, and bating of natural leather;
shaving the prepared fabric to a uniform thickness;
neutralizing the shaved fabric to a pH of 5 to 7;
flame retardant processing of performing a flame retardant treatment on the neutralized fabric with a composition for manufacturing leather; and
drying the flame retardant treated fabric.

2. The method of claim 1, wherein a pickling process is not performed.

3. The method of claim 1, further comprising:
tanning the prepared fabric in a chrome-free tanning method.

4. The method of claim 1, further comprising:
direct-tanning the prepared fabric with nitrogen-based syntans.

5. The method of claim 1, further comprising, after the flame retardant processing,
retanning the flame retardant treated fabric.

6. The method of claim 5, further comprising, after the retanning,
dyeing the retanned fabric using a dye.

7. The method of claim 6, further comprising, after the dyeing,
fatliquoring the dyed fabric with a fatliquoring agent.

8. The method of claim 7, wherein the drying includes, after the fatliquoring, drying the fatliquored fabric.

9. The method of claim 8, wherein the drying includes vacuum drying, wet toggle, natural drying (hanging), humidity control (conditioning), vibration, milling, and toggle.

10. The method of claim 8, further comprising:
finishing a surface of the dried fabric with a binder.

11. The method of claim 1, wherein the composition for manufacturing leather comprises hydroxide and borax (Na₂B₄O₇·10H₂O).

12. The method of claim 11, wherein the composition for manufacturing leather comprises 0.1 to 5 parts by weight of hydroxide; and 0.1 to 5 parts by weight of borax, based on 100 parts by weight of shaving leather.

13. The method of claim 12, wherein the hydroxide contains at least one of 0.05 to 2.5 parts by weight of aluminum hydroxide (Al(OH)₃); and 0.05 to 2.5 parts by weight of magnesium hydroxide (Mg(OH)₂).

14. The method of claim 12, wherein the composition for manufacturing leather further comprises at least one of 1 to 10 parts by weight of a first liquid agent; and 1 to 10 parts by weight of a second liquid agent, based on 100 parts by weight of the shaving leather.

15. The method of claim 14, wherein the first liquid agent contains ceramic, and the second liquid agent contains titanium dioxide.

16. The method of claim 14, wherein the first liquid agent contains 92 to 99% by weight of ethanol; 0.1 to 5% by weight of butanone; and 0.1 to 3% by weight of ceramic.

17. The method of claim 14, wherein the second liquid agent contains 90 to 99% by weight of water; 0.1 to 5% by weight of quartz; 0.1 to 3% by weight of ethanol; and 0.1 to 3% by weight of titanium dioxide (TiO₂).

18. The method of claim 14, wherein the composition for manufacturing leather further comprises, based on 100 parts by weight of the shaving leather, 1 to 10 parts by weight of silica.

19. The method of claim 14, wherein the composition for manufacturing leather further comprises, based on 100 parts by weight of the shaving leather, 1 to 10 parts by weight of a third liquid agent.

20. The method of claim 19, wherein the third liquid agent contains:
50 to 80% by weight of water;
10 to 40% by weight of polydimethyl siloxane hydroxyl terminated; and
1 to 15% by weight of dimethyl siloxane.
